(19) United States
(12) Patent Application Publication
(10) Pub. No.: US 2023/0332345 A1
(43) Pub. Date: Oct. 19, 2023

(54) DIGITAL FABRIC CUTTING

(71) Applicant: Kornit Digital Ltd., Rosh HaAyin (IL)

(72) Inventors: Nir FUNT, Ganei Tikva (IL); Yoel SHAFIR, Petah Tikva (IL); Ran ELIASH, Tel-Aviv (IL)

(73) Assignee: Kornit Digital Ltd., Rosh HaAyin (IL)

(21) Appl. No.: 18/025,411

(22) PCT Filed: Sep. 22, 2021
(86) PCT No.: PCT/IL2021/051153

§ 371 Date: Mar. 9, 2023

Related U.S. Application Data
(60) Provisional application No. 63/081,957, filed on Sep. 23, 2020.

(51) Int. Cl. D06M 11/57; C09K 13/00; D06H 7/22; D06B 11/00

(52) U.S. Cl. CPC D06H 7/226; C09K 13/00; D06B 11/0059; D06M 11/57; D06M 2101/06; D10B 2201/00

(57) ABSTRACT

Provided herein is a process, compositions and machinery for performing digitally chemical cutting of a fabric, using digital inkjet methodologies and machines, being particularly, but not exclusively, suitable for roll-to-roll printing configuration, and based on digital printing of a fabric-cutting composition and a fabric-penetrating composition directly on the fabric to obtain a cut or perforated fabric.

### RELATED APPLICATIONS

This application claims the benefit of priority of U.S. Provisional Pat. Application No. 63/081,957 filed on 23 Sep. 2020, the contents of which are incorporated herein by reference in their entirety.

### FIELD AND BACKGROUND OF THE INVENTION

The present invention, in some embodiments thereof, relates to advanced fabric fashioning and, more particularly, but not exclusively, to chemical processes for digital fabric cutting processes and compositions configured for direct application by a digital inkjet printing machinery and techniques.

Fabric cutting is an essential and time-consuming part of the process in most branches of the apparel industry. Cutting of fabrics is typically done before or after the fabric had been augmented, e.g., by adding patterns and/or colors by printing or other dyeing techniques. Mechanical cutting of fabrics (by shearing, die cut pressing, engraving, embossing, and fade-rubbing) is still the most prevailing methodologies in the industry, however, laser cutting is gaining a foothold in the industry.

Laser is being used in apparel industry from nineteenth century for various garment manufacturing applications, especially for cutting. There are several advantages of using laser over the conventional processes in cutting, nonetheless, laser is still not able to solve problems in fabric cutting of most printed-on fabrics as well as in some cases on pure-cotton white, and thick fabrics, and in most roll-to-roll configurations, where the intense laser energy needed to effect cutting becomes a problem all by itself.

However, both mechanical and laser cutting are not conducive to high-throughput, high linear speed printing modes, such as roll-to-roll printing configurations.

Apart of mechanical or direct energy beam cutting, fabrics can be cut chemically, using fiber-degrading chemicals. Different from devoré, or partial cutting, chemical cutting is still limited to certain types of fabrics in certain types of fabric-handling configurations, and moreover, due to the use of harsh and dangerous chemicals, limited in its practical applicability, especially when considering roll-to-roll fabric processing configurations.

U.S. Pat. App. Pub. No.: 2008/0178394 teaches a fiber-removing process including a mixture of an acidification agent, a thickener, a solvent, a polymer and various modifying agents for producing a design on a cellulose fiber-containing material, a thermoplastic composition for use in the fiber-removing process, as well as a process for applying the composition in a particularized format to a substrate for selectively removing cellulose fibers.

### SUMMARY OF THE INVENTION

Aspect so the present invention are drawn to processes, compositions, machine and algorithms for chemical cutting of fabrics in a roll-to-roll configuration, using elements from digital printing. Also provided herein are products and articles of manufacturing made by using the processes, compositions, machine and algorithms provided herein. The presently disclosed concept of weakening a fabric in a predetermined pattern (perforation) for enabling manual detachment a piece of fabric from a roll, eliminates the need of another step of fabric cutting.

Thus, according to an aspect of some embodiments of the present invention there is provided a process for chemically cutting a fabric by digital methodologies, the process is effected by:
loading the fabric on a printing machine equipped with at least two digital liquid jetting devices;
digitally printing a fabric-cutting composition following a predetermined digital pattern, wherein the composition includes at least one activatable fiber-degrading agent suitable for degrading the degradable fibers; and
digitally printing a fabric-penetrating composition essentially on the same location of the predetermined digital pattern.

According to some embodiments of the invention, the process further includes activating the activatable fiber-degrading agent in the fabric subsequent to the digitally printing.

According to some embodiments of the invention, each of the fabric-cutting composition and the fabric-penetrating composition is formulated for digital inkjet printing.

According to some embodiments of the invention, the fabric-cutting composition and the fabric-penetrating composition are applied on the fabric substantially concomitantly, essentially simultaneously, or sequentially.

According to some embodiments of the invention, the process further includes, prior to the digitally printing, performing a fabric-perforation assay for the fabric, wherein the fabric-perforation assay determines an amount of the activatable fiber-degrading agent that is applied on the fabric per unit area such that a perforated fabric is obtained subsequent to the activating.

According to some embodiments of the invention, each of the digital liquid jetting devices is operated at a resolution of 100-1200 drops per inch (DPI) and a drop size of 4-40 pL.

According to some embodiments of the invention, the resolution is 600 DPI and the drop size 30 pL.

According to some embodiments of the invention, the perforated fabric requires a tearing force of less than about 8 N/cm.

According to some embodiments of the invention, the activation of the fiber-degrading agent includes heating and/or irradiating.

According to some embodiments of the invention, the activation of the fiber-degrading agent is effected in the printing machine.

According to some embodiments of the invention:
the printing machine is a roll-to-roll printing machine;
the fabric is re-rolled onto a downstream roll as a perforated fabric at a tension force that is lower than a tearing force of the perforated fabric.

According to some embodiments of the invention, the tension force is about 1 N/cm.

According to some embodiments of the invention, the activatable fiber-degrading agent is a heat-activated fiber-degrading agent, and its activation includes heating.

According to some embodiments of the invention, heating is effected to at least 110° C.

According to some embodiments of the invention, heating is effected for at least 2 minutes.

According to some embodiments of the invention, the heat-activated fiber-degrading agent is an acid-releasing substance.

According to some embodiments of the invention, the fabric essentially includes only cellulosic fibers.

According to some embodiments of the invention, fiber-degrading agent is selected from the group consisting of aluminum sulfate, sodium aluminum sulfate, sodium bisulfate, copper(II) sulfate, iron(II) sulfate, cobalt(III) sulfate, iron(III) sulfate, zinc sulfate, sodium hydrogen sulfate, sodium dihydrogen phosphate, sodium hydroxide, an acid-releasing polymer, and any combination thereof.

According to some embodiments of the invention, fiber-degrading agent is aluminum sulfate.

According to some embodiments of the invention, the fabric-penetrating composition that includes a colorant.

According to some embodiments of the invention:
the printing machine is a roll-to-roll printing machine that further includes an upstream roll, a downstream roll, and a heating station;
the fabric that includes only cellulosic fibers;
the activatable fiber-degrading agent is aluminum sulfate;
the fabric-penetrating composition further includes a colorant (a dye or a pigment; preferably a pigment);
the fabric-cutting composition and the fabric-penetrating composition are digitally printed on the fabric substantially concomitantly, essentially simultaneously, or sequentially, each from one of the at least two digital liquid jetting devices;
wherein the amount of the fabric-cutting composition and the fabric-penetrating composition is selected to afford a perforated fabric, the perforated fabric is characterized by a tearing force that is lower than a tearing force of the fabric on the upstream roll and higher than a tension force of the downstream roll; and the activation of the fiber-degrading agent is effected by heating to at least 110° C.

According to another aspect of embodiments of the present invention, there is provided a perforated fabric, obtained by the process essentially as disclosed herein.

In some embodiments, the perforated fabric is characterized by a tearing force that ranges 1-10 N/cm. Preferably higher than the rolling tension of a roll-to-roll printing machine.

In some embodiments, the perforated fabric is characterized by a cutting pattern marked by a colorant.

In some embodiments, the perforated fabric is characterized by a spectral feature characteristic to a fabric cut by the activatable fiber-degrading agent.

In some embodiments, the perforated fabric is in a form of a roll of pre-cut perforated fabric.

According to another aspect of embodiments of the present invention, there is provided a cut fabric, obtained by the process disclosed herein, or optionally obtained by tearing a perforated fabric obtained by the process as disclosed herein.

In some embodiments, the cut fabric is characterized by a spectral feature characteristic to a fabric cut by the activatable fiber-degrading agent.

According to another aspect of embodiments of the present invention, there is provided a fabric cutting composition, suitable for the process essentially as disclosed herein.

In some embodiments, the fabric cutting composition is formulated for digital inkjet printing from an inkjet digital liquid jetting device.

In some embodiments, the fabric cutting composition includes an activatable fiber-degrading agent at a concentration of less than 5 wt% of the total weight of the composition.

In some embodiments, the fabric cutting composition includes deionized water and at least one of a rheology modifier, a wetting agent, a surfactant, an antibacterial agent, a fungicide and an anticorrosion agent, and optionally at least one colorant.

In some embodiments, the fabric cutting composition further includes a colorant.

In some embodiments, the fabric cutting composition is substantially devoid of a colorant.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents a photograph of the cotton fabric cut using the digital cutting composition and process essentially as described herein; and

FIGS. 2A-C present photographs of the cotton fabric cut using the digital cutting composition and process essentially as described herein, wherein FIG. 2A shows the post-process tearing/cutting step and encircled areas 21 shown in FIG. 2B, FIG. 2B is the magnified version of encircled area 21 in FIG. 2A, showing colored cutting pattern 22 and image 23, and FIG. 2C shows the finished cut piece of fabric.

### DESCRIPTION OF SPECIFIC EMBODIMENTS OF THE INVENTION

The present invention, in some embodiments thereof, relates to advanced fabric fashioning and, more particularly, but not exclusively, to chemical processes for digital fabric cutting processes and compositions configured for direct application by a digital inkjet printing machinery and techniques.

The principles and operation of the present invention may be better understood with reference to the figures and accompanying descriptions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

Being experts in the field of digital inkjet technologies, the present inventors contemplated combining chemical cutting with digital inkjet printing - basing their assumptions on the ability of digital printing to deliver small and precise amounts of liquids to the surface of a substrate at a very high amount and location precision and accuracy. While conceiving the present invention, the inventors have thought of an integrated inkjet printing and chemical cutting process that can be implemented in any digital printing process, including roll-to-roll configuration, claiming the benefits of digital manipulation of small and precise amounts of chemicals - inks and fiber-degrading compositions - all being deposited on the fabric by digitally-operated printing machines and printheads, and all being applied, set, cured, activated and disposed of by elements found in most digital printing machines.

While conceiving the present invention, the present inventors have contemplated the use of a composition that will be suitable for inkjet settings, and at the same time will include substances that can degrade at least some types of fibers used in the textile industry, such as cellulosic fibers, proteinous fibers or synthetic fibers, in a controllable manner. By controllable, it is meant that the fiber-degrading capacity of the composition could be turned on (and off) under conditions that are at the hand of the user, thereby asserting that these fabric-corrosive chemicals are used sparingly and that their activation towards fiber degradation can be controlled by the user.

Furthermore, for processes implemented in an R2R configuration, fully cutting the rolled fabric would impede the purpose of the process, hence cutting would have to be finely tunable, going from fiber-weakening towards fabric cutting via the stage of chemical fabric perforation. Thus, an exemplary end-product of the presently disclosed process is a roll of a chemically-perforated fabric, which upon unrolling can easily be pulled and torn apart along a predetermined cutting pattern into pieces that have been outlined by “printing” a heat-activated fabric-cutting composition. The fabric is therefore not fully cut in the process, but is being perforated (weakened) sufficiently for simple pulling apart step, and until that taring step, stay sufficiently intact to be capable of being rolled back into a continuous roll of fabric at the end of the instantly-disclosed process.

While reducing the present invention to practice, it was observed that in some cases adding at least one other ink, clear or colored, essentially on the same locations (pattern) where the fabric-cutting composition was or will be deposited, improved the penetration of the fiber-degrading substance into the fabric, allowing a more uniform and clean-cut once the agent is activated during the curing (heating) step of the process. Without being bound by any particular theory, it is assumed that since the fabric-cutting composition is formulated for inkjet printing, including high-resolution printing, it is required to exhibit minimal viscosity that retards the penetration of the composition into the fabric. This penetration problem could be mitigated by applying more of the composition onto the same locations, but that would impede the effort to minimize the amount of the fiber-degrading substance that is being applied on the fabric and shorten the time of the process, however, the inventors have found that printing any one of the other inks that already take part in the process, not only mitigates the penetration problem, but also adds a beneficial marking of the perforation pattern without adding another printhead, and therefore another channel, to the printing machine.

### Digital Fabric Cutting Process

In the context of the present disclosure, the term “cutting” and the term “perforating” are used interchangeably to denote the action of the fabric-cutting composition on the fabric. In general, the active substance in the fabric-cutting composition is capable of degrading the fibers of the fabric such that the fabric is no longer present, or notably weakened at the location where the composition was applied and activated, namely the composition is capable of forming holes and gaps in the fabric. Alternatively, the composition can be applied along a pattern (e.g., a line) and weaken the fabric to a state where it is easily torn (split) along the pattern, whereas a close look at the fabric after the fiber-degrading agent had been activated, may reveal a series of small and unconnected holes in the fabric along the pattern, or show no visible signs in some or the entire pattern, however, the fabric will split along the pattern when sufficient tearing force is applied on the fabric. Hence, the term “perforation” is used to denote the action of the process on the fabric, which leads to cutting the fabric or leads to sufficient weakening thereof.

While reducing the present invention to practice, it was observed that printing only the fabric-cutting composition along the predetermined pattern, resulted in partial perforation which was not sufficient to allow clean tearing of the fabric along the pattern. Close observation revealed that the composition did not penetrate deep enough into the fabric, during the process. Applying more of the fabric-cutting composition on the same pattern by printing larger and/or more drops of the composition, or increasing the concentration of the fiber-degrading agent in the composition may afford sufficient penetration of the fiber-degrading agent into the fabric, but at a cost of precision and wasteful use of the fabric-cutting composition, which is not only costly, but also environmentally harmful and unwarranted. It was hypothesized that being formulated for inkjet printing, the requirement for a certain viscosity of the fabric-cutting composition is also the reason for its slow penetration into the fabric, and although the concentration of the fiber-degrading agent in the composition is sufficient, the fiber-degrading agent does not reach through the fabric to effect acceptable perforation. Since reducing the viscosity of the composition, or increasing the concentration of the fiber-degrading agent, were found impractical or less desirable, the inventors contemplated a second deposition of another jetable composition along the same pattern, such that the viscosity of the fabric-cutting composition and the concentration of the fiber-degrading agent therein are kept optimal, while the second composition assists in driving the fiber-degrading agent deeper into the fabric. In the context of the present invention, that other composition that assists in driving the penetration of the fiber-degrading agent into the fabric is referred to as “fabric-penetrating composition”.

Thus, according to an aspect of some embodiments of the present invention, there is provided a process for chemically cutting a fabric, which is effected by:
loading the fabric on a printing machine equipped with at least two digital liquid jetting devices, such as printheads;
digitally printing a fabric-cutting composition following a predetermined digital pattern; and
digitally printing a fabric-penetrating composition essentially on the same location of the predetermined digital pattern.

Thus, digital chemical cutting of a fabric, comprising, or essentially comprising only of degradable fibers, such as cellulosic and/or proteinous fibers, is effected by deploying a digital fabric-cutting composition which includes an activatable cellulosic- and/or proteinous fiber-degrading agent. If no impervious fibers are present in the fabric, the fabric is cut at the locations on which the fabric- cutting composition is printed (a cutting pattern); for example, to cut a cellulosic fabric along a line, the process includes printing a fabric-cutting composition comprising a cellulosic fiber-degrading agent and a fabric-penetrating composition in a pattern of a line.

The phrase “digital liquid jetting device”, as used herein, refers to any element in a printing machine that can be used to execute the application of a liquid composition in a digital printing setup, and follow commands from the processing unit of the printing machine to print the liquid composition in a predetermined digital pattern. An exemplary digital liquid jetting device includes, without limitation, continuous inkjet printheads, drop-on-demand printheads, valve jets, and spray nozzles. It is noted herein that the most accurate digital liquid jetting device and thus the most economical digital liquid jetting device is preferable when considering cost, time (e.g., for drying), environment, and quality of the result. In addition, it is preferable to use digital liquid jetting devices that are already in use on the given printing machine. Preferably, the digital liquid jetting device is a drop-on-demand digital inkjet printhead, however, other digital liquid jetting devices are contemplated within the scope of the present invention.

The phrase “predetermined digital pattern”, as used herein, refers to a predetermined design, such as linear and/or curved lines, dots, areas and any combination thereof, which is translated into a set computer-edited, compiled, stored, delivered and executed digital commands. The digital commands are carried out by a digital inkjet printing machine that directly places droplets of a liquid composition, such as the composition for digital cutting of a fabric presented herein, on a surface of a substrate (e.g., a fabric), the coverage of which corresponds to the predetermined design. By stating that the fabric-cutting composition the fabric-penetrating composition are digitally printing by the same pattern, it is meant that the two compositions are printed essentially on the same locations on the fabric; the term “essentially” in the phrase “essentially on the same location of said predetermined digital pattern” is used to denote that droplets of the two compositions are meant to hit the fabric at the same location, or at high areal proximity.

In some embodiments of the process for digital cutting of fabrics, the digital cutting composition includes a proteinous fiber-degrading agent, and the fabric comprises at least some proteinous fibers.

In some embodiments of the process for digital cutting of fabrics, the fabric-cutting composition includes a cellulosic fiber-degrading agent, and the fabric comprises at least some cellulosic fibers.

In some embodiments of the process for digital cutting of fabrics, the fabric includes at least some cellulosic fibers and some synthetic and/or proteinous fibers. The total amount of cellulosic fibers in the fabric may range from 5% to 80% of the total fibers in the fabric.

In some embodiments of the process for digital cutting of fabrics, the fabric essentially comprising only cellulosic fibers. In such embodiments, the process for digital cutting of fabrics can be used to cut the fabric according to a predetermined digital pattern, since the fabric is made entirely of fibers that can be degraded by the fiber-degrading agent in the fabric-cutting composition. In order to effect perforation or cutting of the fabric, the process further includes, subsequent to the step of digitally printing the fabric-cutting and fabric-penetrating compositions, heating the printed fabric to at least 110° C. to thereby degrade the fibers, e.g., cellulosic fibers. In some embodiments, the process further includes, subsequent to the heating step, tearing the fabric along the perforation lines of the pattern, and/or removing and cleaning residues of the degraded fibers. Tearing is effected manually or mechanically, by any method known ion the art. Cleaning the residues of the degraded fibers is effected by wet or dry cleaning, washing, air blowing, shaking and agitating the fabric, and any method known in the art for removing debris and loose fibers from a fabric.

In some embodiments of an aspect of the present invention, the digital cutting process includes the use of a cutting-annulling composition that includes a neutralizing agent capable of preventing, attenuating and/or arresting the cutting reaction effected by a corresponding cutting agent. The process includes applying to the substrate a cutting-annulling composition on the substrate before, during and/or after applying a digital cutting composition as provided herein, wherein the cutting-annulling composition is applied on areas of the substrate where cutting is required to be prevented, attenuated and/or arrested.

In some embodiments, the cutting-annulling composition is formulated for ejection from inkjet machinery, as defined hereinabove.

According to some embodiments of the present invention, the process may further include printing one or more ink composition comprising a colorant (dye or pigment) on the fabric. The color printing can be effected on non-cutting areas of the fabric, on cutting areas or in any part of the fabric, regardless of the cutting pattern. Printing on the fabric can be carried out by any printing protocol, method and process, before the fabric is printed with the fabric-cutting and fabric-penetrating compositions, after printing the fabric-cutting and fabric-penetrating compositions, and before or after the fabric is heated. Any color printing methodology is contemplated within the scope of the present invention.

In some preferred embodiments, the fabric-penetrating composition is one of the colored inkjet inks that is used to print an image on the fabric. The ink doubles as a process colored ink as well as a fabric-penetrating composition.

As discussed hereinabove, each of the fabric-cutting composition and the fabric-penetrating composition is independently formulated for digital inkjet printing in terms of viscosity, particle size, surface tension, and other properties which are required from a composition intended for application from any digital liquid jetting device including a digital inkjet printhead.

Preferably, the fabric comprises degradable fibers, and the fabric-cutting composition comprises at least one fiber-degrading agent suitable for degrading these degradable fibers.

Further preferably, the fiber-degrading agent is activatable, namely that for substantial perforation of the fabric, the fiber-degrading agent requires activation, before which it is substantially unreactive with respect to the fabric, as will be discussed in more details below -such a substance is referred to herein as an “activatable fiber-degrading agent”. Hence, in some embodiments, the process further includes activating the activatable fiber-degrading agent in the fabric subsequent to digitally printing the fabric-cutting composition and the fabric-penetrating composition.

The order of printing the fabric-cutting composition and fabric-penetrating composition can be any order, as long as the time between the two printing passes is kept minimal. In most contemporary printing machines, two compositions can be applied essentially concomitantly, essentially simultaneously, or sequentially, with one being printed between fractions of a second to a few seconds before the other.

The amount of the compositions to be printed on the fabric may vary depending on the type and thickness of the fabric, density and thickness of the fibers and other parameters and properties thereof. Thus, as part of the process, at least on some embodiments of the invention, the process may include conducting an assay for the given fabric to be cut. Hence, prior to the printing process, the user may perform a fabric perforation assay for the fabric, by which the amount of the activatable fiber-degrading agent that should be applied on the fabric per unit area is determined, such subsequent that a perforated fabric is obtained. A fabric perforation assay is a simple printing test of the compositions in a series of amounts, followed by activation of the fiber-degrading agent and a metered tearing test at a constant tearing force, which will be discussed hereinbelow. Once the desired level of perforation is achieved, the amount of each of the compositions is determined for the given fabric.

While reducing the present invention to practice, certain values of printing parameters were found useful, at least for some fabrics. For example, in some preferred embodiments, each of the digital liquid jetting devices, one for the fabric-cutting composition and one for the fabric-penetration composition, is operated at a resolution of 100-1200 drops per inch (DPI) and a drop size of 4-40 pL. In some embodiments, the printing resolution is 600 DPI and the drop size 30 pL. Preferably, the resolution of the printing process is set to the desired quality of the color images that are printing on the fabric, whereas the printing parameters of the fabric-cutting and fabric-penetrating compositions are typically set to match the printing parameters of the colored inks.

Such printing resolution and amounts, combined with an effective activatable fiber-degrading agent, results in a perforated fabric having a level of perforation that is defined, for example, by the force needed to split (tear) the fabric along the predetermined cutting pattern. Hence, a preferred level of perforation is such that requires a tearing force of less than about 15 N/cm, less than about 12 N/cm, less than about 10 N/cm, less than about 8 N/cm, less than about 6 N/cm, less than about 4 N/cm, or less than about 2 N/cm. The preferred level of perforation can therefore be controlled and adjusted to the parameters and conditions of various features of the printing process and machine and the needs and preferences of the user of the process; for example the speed and tension by which the perforated fabric is driven in the machine - the perforated fabric should not exhibit a perforation level that is lower than the tension force applied by any parts of the printing machine in order to avoid premature splitting and/or unintentional tearing of the fabric. The level of perforation should also be sufficient to allow easy and cleat tearing of the fabric.

In some embodiments, the perforation level is set to effect complete cutting of the fabric, namely the end result of the process is a cut fabric rather than a perforated fabric, such that no tearing is required to cut the fabric.

In some embodiments the activation of the fiber-degrading agent is effected off-line of the printing process, whereas the printed fabric is manually moved to an activation machine to complete the cutting/perforation process. In some preferred embodiments, the entire fabric cutting process is effected in-line on a printing machine which is equipped with an activation station. In some embodiments, the activation station is a common part of an integrated printing machine - for example, a drying/curing station (e.g., a heating station, an oven, a heat-press, a hot-air chamber, an IR irradiation chamber, and the likes), where the fabric is passed through to effect curing the inks and drying the fabric after the colored ink printing is completed. According to some embodiments, the activation of the activatable fiber-degrading agent is equivalent and similar to the inks drying/curing step in any standard printing process.

Preferably, the activation step of the process presented herein is effected by heat, which may be exerted on the printed fabric by any mean known in the art, as most of the widely used forms of heating a printed fabric will also activate a suitable heat-activatable fiber-degrading agent.

Thus, according to some embodiments of the present invention the process includes the use of an activatable fiber-degrading agent that is a heat-activated fiber-degrading agent, and the process further includes an activating step that comprises heating the printed fabric. In some embodiments, the heating is effected to at least 110° C. In some embodiments, the heating is effected for at least 2 minutes.

### R2R Fabric Cutting Process

Roll-to-roll (R2R) is a family of manufacturing techniques involving continuous processing of a flexible substrate as it is transferred between at least two moving rolls of material, an upstream roll that feeds the process, and a downstream roll that rerolls the processed substrate. R2R is an important class of substrate-based manufacturing processes in which additive and subtractive processes can be used to build structures in a continuous manner. R2R is a “process” comprising many technologies that, when combined, can produce rolls of finished processed material in an efficient and cost-effective manner with the benefits of high production rates and in mass quantities. High throughput and low cost are the factors that differentiate R2R manufacturing from conventional manufacturing which is slower and higher cost due to the multiple steps involved, for instance, in batch processing.

Currently, R2R printing and cutting are carried out as two separate processes. First, printing is effected on the fabric roll, followed by curing the freshly deposited inks using hot air or radiation ovens, then rolling back the roll, or not, thereafter the roll is taken to the next step of mechanical or beam energy cutting (scissors, knives, dies or lasers). Nonetheless, the concept of digital chemical cutting is still not known in the textile printing industry.

Being experts in the field of digital inkjet technologies in general, and in digital printing on textiles in particular, the present inventors contemplated combining digital-chemical cutting in an R2R configuration - basing their assumptions on the ability of digital printing machinery and methodologies to deliver small and precise amounts of liquids to the surface of a moving substrate at a very high amount and location precision and accuracy. The solution to the problems discussed above were solved by selecting fabric-cutting chemical reactions and designing the corresponding chemical compositions that would afford the optimal results under R2R settings - a fabric-cutting composition that allows a delayed and controlled initiation of fiber degradation reaction using a fiber-degrading agent that can be applied rapidly, accurately, sparingly, safely and effectively on a rapidly moving fabric substrate, assisted by a fabric-penetration composition to deliver the reagents deep into the fabric before the next step of activation/curing/drying takes place, and yet allow the processed fabric to be rerolled back into the downstream roll without breaking prematurely, and without effecting uncontrolled and undesired fabric cutting, soiling or otherwise unintentionally damaging the fabric and/or the machine where not warranted.

Hence, according to some embodiments of the present invention, the fabric cutting process presented herein is effected on a roll-to-roll printing machine, that includes, besides at least two digital liquid jetting devices, also an upstream roll of pristine fabric, and a downstream roll to collect the processed, namely to re-roll the perforated fabric, and a mean for activating the fiber-degrading agent. The means for activation may be, in some embodiments, a standard downstream curing station in the form of a hot-air or a radiation oven.

As typically done in R2R configuration, the downstream roll is rolled under a certain tension, which is exerted on the processed and re-rolled substrate, which is a perforated fabric according to some preferred embodiments of the present invention, in order to obtain a tight roll. In the context of the present invention, this force, or re-rolling tension force, is typically about 1 N/cm. This tension force can be adjusted to suit the tearing force of the processed fabric, or alternatively, the tearing force can be adjusted to an optimal value by selecting suitable fiber-degrading agent, its concentration in the fabric-cutting composition, and the amount of this composition being printed on the fabric. Regardless of which is adjusted to which, according to some preferred embodiments of the present invention, the downstream roll is rolled at a tension force that is lower than the tearing force of the perforated fabric.

In general the presently disclosed process in a R2R configuration includes:
In case the fabric is used for the first time executed a fabric perforation assay for the fabric in order to determine the amount of the fabric-cutting composition and the fabric-penetrating composition, which is optimal to afford a perforated fabric, such that perforated fabric is characterized by a tearing force that is lower than the tearing force of the pristine fabric on the upstream roll and higher than a tension force used to re-roll the downstream roll;
Loading a roll of pristine fabric, preferably comprising only cellulosic fibers, on a roll-to-roll printing machine, equipped at least with at least two digital liquid jetting devices, such as inkjet printheads, at least one for the fabric-cutting composition and at least one for the fabric-penetration composition, and an activation station, preferably a heating station;
Digitally printing a fabric-cutting composition following a predetermined digital pattern, preferably comprising aluminum sulfate as the activatable fiber-degrading agent;
Digitally printing, substantially concomitantly, essentially simultaneously, or sequentially, with the fabric-cutting composition, a fabric-penetrating composition, preferably comprising a colorant, preferably a pigment, following the same predetermined digital pattern;
Activating the printed fabric in the activation station, preferably by heating the printed fabric to at least 110° C.; and
Re-rolling the processed fabric on the downstream roll.

The process may further be completed by mechanically or manually splitting (cutting) the processed fabric along the perforation or predetermined cutting pattern.

### Digital Fabric-Cutting Machine

In contemporary digital textile printing industry, a designated machine is needed for printed fabric roll cutting, wherein the garment is pretreated, printed, dried and then cut and packaged. According to some embodiments of the present invention, a single integrated system for in-line digital printing and chemical cutting is provided herein. The benefits of using such integrated system include, without limitation, cutting that is carried out digitally using a digital fabric-cutting composition as described herein; and use of inkjet technology to accurately carry out integrated printing and chemical cutting.

A chemical fabric-cutting formulation in the form of the presently provided fabric-cutting composition combined with the presently provided fabric-penetrating composition, can be jetted through any digital liquid jetting device, like an inkjet printhead, which forms a part of an inkjet printing machine or system. The digital liquid jetting device is be mounted on a carriage. A Drop-On-Demand printhead prints a high resolution line, which allows the digital cutting composition to be placed exactly where the chemical cutting process is needed. The printing and cutting processes occur continuously without interfering or adding an additional stages to the process. The fabric stays in one piece and the fabric-cutting reaction starts only when the printed fabric undergoes the activation step, leading to perforation of separation of the fabric into pieces, ready for additional cleaning, sewing or finishing processes.

This integrated solution is an important and innovated part in the digital printing field which offers the user to print an individual or a single print and cut it easily without using any additional tools or machines.

Thus, according to some embodiments of an aspect of the present invention, there is provided a digital fabric-cutting machine, which is designed to effect perforation and/or cutting of a fabric using inkjet technologies and methodologies, as disclosed herein.

In some embodiments of the present invention, the digital fabric-cutting machine is equipped with at least one digital liquid jetting device that is designated to digitally ejecting a fabric-cutting composition, as described herein, and at least one digital liquid jetting device to deploy a fabric-penetrating composition. The machine may further include one of more digital liquid jetting devices for printing colored inkjet inks, and further may optionally include another digital liquid jetting device, like a printhead or a nozzle for jetting a cutting-annulling composition, as described herein.

Suitable printheads useful for jetting the compositions presented herein, according to some embodiment of the present invention, include, without limitation, Kyocera-KJ4B Series (e.g., KJ4C-0360), SII printek-Seiko (e.g., RC1536), Konica Minolta (e.g., KM1800i), Ricoh (e.g., MH5420/5440; GH2220; and MH2620), Trident (e.g., 256JET-S), XAAR (e.g., 2001+; 1201; and 5601), and Spectra (e.g., SG1024; samba; GMA; PQ 35pl; and PQR S\M\L).

The machine is driven by a software that follows an algorithm, which is designed to drive the digital liquid jetting device(s) according to a predetermined digital pattern, as described herein.

The machine and algorithm can be designed in and for any configuration known in the inkjet field, including a roll-to-roll configuration, a single station configuration, a matrix configuration and a carousel configuration, as these are known in the art.

### Fabric-Cutting Composition

In the context of the present disclosure, the terms “fabric-cutting composition”, “fabric-perforating composition”, and “fiber-degrading composition” are used interchangeably herein and throughout. Similarly, in the context of a fabric-cutting composition, the term “substance”, “agent”, “compound”, and the likes, are used interchangeably to refer to the ingredient in the composition that degrades the fiber. The term “activatable” in conjunction with “substance”, “agent”, “compound”, refers to the ingredient that is substantially inactive as a fabric perforating/degrading/cutting before it undergoes activation, whereas the activation can be effected by heat, radiation, and a combination thereof. For example, according to embodiments of the present invention, a heat-activated fiber-degrading agent is an ingredient in the fiber-cutting composition that will not cut the fabric substantially when applied on the fabric until it is heated. It is noted that in the context of the present invention, an activatable fiber-degrading agent can be a substance characterized by a low reactivity kinetics, which in practice means it is inactive in the timeframe of a typical printing process, and which may still exhibit some level of reactivity given sufficiently long time. While it is still capable of causing fiber degradation, such a fiber-degrading agent will not be practical for use unless it is activatable, which means that once it is activated, its reactivity increases to a level that can afford the desired result within the timeframe of a typical printing process. On the other hand, a fiber-degrading substance that does not require activation, and its reactivity is high enough to degrade fibers upon contact, is also impractical, as the fabric will begin to degrade while the process is still running, causing discontinuity in the process and possible damaging the printing machine.

According to an aspect of embodiments of the present invention, there is provided a composition that is formulated for ejection from inkjet machinery (an inkjet-suitable composition), which includes an activatable fiber-degrading agent and a carrier, the activatable fiber-degrading agent selectively degrades, corrodes, etches, digests or carbonizes cellulosic and/or proteinous fibers, collectively referred to herein as degradable fibers. Herein and throughout, the term “degrade” refers to the effect of contacting a cellulosic or proteinous fiber with a cellulosic or proteinous fiber-specific cutting agent upon heating, respectively. A cutting agent which is intended to cutting cellulosic fibers selectively is referred to herein as a cellulosic activatable fiber-degrading agent. A cutting agent which is intended to cutting proteinous fibers selectively is referred to herein as a proteinous activatable fiber-degrading agent. For example, fabrics comprising silk and cotton fibers can be cut in the presently disclosed process by using a fabric-cutting composition that includes a cellulosic fiber-degrading agent and a proteinous fiber-degrading agent.

The concentration the concentration of the fiber-degrading agent in the fabric-cutting composition may be determined more accurately per a given fabric, and printing machine setup, and can further be determined using the fabric-perforation assay described herein. According to some preferred embodiments of the present invention, the concentration of the fiber-degrading agent in the fabric-cutting composition is less than about 5 wt% of the total weight of the composition.

The phrase “formulated for ejection from inkjet machinery” and the term “inkjet-suitable”, in the context of a composition that includes an activatable fiber-degrading agent, refers to the combined chemical and mechanical properties of the composition and the agent being suitable for jetting from a digital liquid jetting device, which include any one or more properties, such as viscosity that is suitable for inkjet application from an inkjet printhead (e.g., 2-25 centipoise), a formulation that will allow direct ejection of composition droplets controllably in terms of drop size, location on the substrate, drop density on the substrate and other controllable parameters, a formulation that will allow the droplets to soak into the fabric to reach the fibers it is made of, a reactivity that is substantially harmless to inkjet machinery parts (non-corrosive and non-volatile) yet reactive upon heating to degrade at least some of the fibers constituting the fabric, and being safe for use in terms of work environment and end-user safety (non-toxic and non-flammable).

In general, any composition to be inkjet-suitable, including the fabric-cutting composition, is formulated so as to be characterized by at least one of:
a maximal particle size of less than 1 microns;
a dynamic viscosity at shear that ranges from 2 to 25 centipoise;
a Brookfield viscosity less than 25 centipoises at printing temperature; and
a surface tension that ranges from 24 to 35 mN/m.

Preferably, an inkjet-suitable composition is characterized by all of the above characteristics, or at least most thereof.

In terms of other ingredient of the composition which are used to render the composition inkjet-suitable, according to some embodiments of the present invention, the carrier is deionized water, and the composition further includes any one or more of a wetting agent (humectant) such as glycerin and/or any glycol ether, a thickening agent (rheology modifier) such as polyvinylpyrrolidone, a surfactant such as Dynol 360 or Byk 348, an antibacterial agent, a fungicide and an anticorrosion agent.

In the context of embodiments of the present invention, the term “activatable fiber-degrading agent”, refers to a substance that can controllably degrade at least one type of a fiber used in textile, such as cellulosic fibers or proteinous fibers. Cellulosic fibers include, without limitation, cotton fibers, jute fibers, flax fibers, hemp fibers, ramie fibers, sisal fibers and/or coir fibers, in any combination. Proteinous (animal) fibers include, without limitation, silk fibers, wool fibers and hair fibers.

In some embodiments, at least one type of fiber used in the textile industry is impervious to the activatable fiber-degrading agent, such as synthetic fibers. Synthetic fibers that are typically used in the production of fabrics as threads and otherwise, include polyester fibers, polyurethane fibers, polyamide fibers, polyacryl fibers, polyolefin fibers, polybenzimidazole fibers, and any copolymer thereof, Nylon fibers, polyacrylonitrile (Modacryl) fibers, Rayon fibers, Vinyon fibers, Saran fibers, Spandex fibers, Vinalon fibers, Aramid fibers, Modal® fibers, Dyneema® fibers and Spectra® fibers, and combination thereof.

In some embodiments, the activatable fiber-degrading agent is a proteinous-selective cutting agent, namely an agent that degrades proteinous fibers, while cellulosic and synthetic fibers are impervious thereto. Proteinous-selective cutting agents include, without limitation, amide-bond hydrolysis agents and catalysts, proteolytic enzymes and a combination thereof.

In some embodiments, the activatable fiber-degrading agent is a cellulosic-selective cutting agent, namely an agent that degrades cellulosic fibers, while proteinous and synthetic fibers are impervious thereto.

In some embodiments, optional activatable fiber-degrading agents include aluminum sulfate, sodium aluminum sulfate, sodium bisulfate, copper(II) sulfate, iron(II) sulfate, cobalt(III) sulfate, iron(III) sulfate, zinc sulfate, sodium hydrogen sulfate, sodium dihydrogen phosphate, sodium hydroxide, an acid-releasing polymer, and any combination thereof. In some preferred embodiments, the activatable fiber-degrading agent is aluminum sulfate.

In some embodiments, the fabric-cutting composition may include a colorant, in the forms of a dye or pigment, which will be marking the cutting pattern on the fabric for easy identification of the cutting pattern.

In some embodiments, the fabric-cutting composition is devoid of any colorant, optionally leaving no mark on the fabric except degradation of the fibers.

Suitable substances for fabric-cutting compositions may include some types of polymeric surfactants and dispersants, typically used to disperse solids and other insoluble in water, that can release a strong acid when heated, and this acid can carbonize cellulosic fibers selectively when applied at a suitable concentration and conditions. It was contemplated that when used in an aqueous composition, these acid-releasing polymers are harmless to inkjet machinery (digital liquid jetting devices, surfaces, and environment), and can therefore be applied by printing the composition using digital liquid jetting device, such as an inkjet printhead, to form any predetermined digitally designed pattern. It was contemplated that the reactivity of such acid-releasing polymers can be employed to cut fabrics made of cellulosic fibers, and while reducing the present invention to practice, pure cellulosic fiber fabrics were cut along a line that a composition comprising an acid-releasing polymer was printed along using a standard digital liquid jetting device, while a fabric essentially comprising only synthetic fibers was impervious to the composition.

In some embodiments of the present invention, the cellulosic-selective cutting agent is an acid-releasing cutting agent, such as an acid-releasing polymer, which is combined with a suitable carrier in a composition for digital cutting of fabrics. This composition is particularly useful for digital cutting of mixed fiber fabrics which include cellulosic fibers, and digital cutting of pure cellulosic fabrics. In the context of some embodiments of the present invention, an acid-releasing polymer is cellulosic-selective cutting agent. In some embodiments, the acid which is release from the polymer under controlled conditions, such as heating, is phosphoric acid.

In some embodiments of the present invention, the concentration of the acid-releasing polymer in the composition ranges from about 5 percent to 20 percent by weight of the total weight of the composition (% wt).

In some embodiments, the acid-releasing polymer is characterized by an average molecular weight that ranges from 2,000 g/mol to 10,000 g/mol, or from 3,000 g/mol to 8,000 g/mol, from 3,000 g/mol to 5,000 g/mol, from 2,000 g/mol to 7,000 g/mol.

The acid-releasing polymer is selected to be harmless to the inkjet machinery by not being corrosive thereto, therefore the composition comprising the acid-releasing polymer is substantially devoid of a corrosive agent, and is also non-degrading to fabrics until it is heated. The composition comprising the acid-releasing polymer is designed to release an acid upon heating the composition, typically after it has been applied on the fabric. In some embodiments, the composition releases an acid when it is heated to, or when the fabric it is applied on is heated to at least 160° C., at least 170° C., at least 180° C., at least 190° C. or at least 200° C. and higher.

In some embodiments of the present invention, the acid-releasing polymer exhibits an alkyl phosphate group, an alkyl-alkoxy phosphate groups and/or a combination thereof.

The term “alkyl phosphate”, as used herein, refers to a R-OP(=O)(OH)₂ or a R-OP(=O)(OH)O⁻ group, wherein R is an alkyl.

The term “alkyl-alkoxy phosphate”, as used herein, refers to a R-OP(=O)(OH)OR′ or a R-OP(=O)(OR′)O⁻ group, wherein R and R′ are each an alkyl.

As used herein, the term “alkyl” describes an aliphatic hydrocarbon including straight chain and branched chain groups. The alkyl group may exhibit 1 to 20 carbon atoms, and preferably 8-20 carbon atoms. Whenever a numerical range; e.g., “1-20”, is stated herein, it implies that the group, in this case the alkyl group, may contain 1 carbon atom, 2 carbon atoms, 3 carbon atoms, etc., up to and including 20 carbon atoms. The alkyl can be substituted or unsubstituted, and/or branched or unbranched (linear). When substituted, the substituent can be, for example, an alkyl, an alkenyl, an alkynyl, a cycloalkyl, an aryl, a heteroaryl, a halo, a hydroxy, an alkoxy and a hydroxyalkyl as these terms are defined herein. The term “alkyl”, as used herein, also encompasses saturated or unsaturated hydrocarbon, hence this term further encompasses alkenyl and alkynyl.

The term “alkenyl” describes an unsaturated alkyl, as defined herein, having at least two carbon atoms and at least one carbon-carbon double bond. The alkenyl may be branched or unbranched (linear), substituted or unsubstituted by one or more substituents, as described herein.

The term “alkynyl”, as defined herein, is an unsaturated alkyl having at least two carbon atoms and at least one carbon-carbon triple bond. The alkynyl may be branched or unbranched (linear), and/or substituted or unsubstituted by one or more substituents, as described herein.

The terms “alicyclic” and “cycloalkyl”, refer to an all-carbon monocyclic or fused ring (i.e., rings which share an adjacent pair of carbon atoms), branched or unbranched group containing 3 or more carbon atoms where one or more of the rings does not have a completely conjugated pi-electron system, and may further be substituted or unsubstituted. The cycloalkyl can be substituted or unsubstituted by one or more substituents, as described herein.

The term “aryl” describes an all-carbon aromatic monocyclic or fused-ring polycyclic (i.e., rings which share adjacent pairs of carbon atoms) groups having a completely conjugated pi-electron system. The aryl group may be substituted or unsubstituted. Substituted aryl may have one or more substituents as described for alkyl herein.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Representative examples of heteroaryls include, without limitation, furane, imidazole, indole, isoquinoline, oxazole, purine, pyrazole, pyridine, pyrimidine, pyrrole, quinoline, thiazole, thiophene, triazine, triazole and the like. The heteroaryl group may be substituted or unsubstituted as described for alkyl herein.

The term “halo” refers to —F, —Cl, —Br or —I.

The term “hydroxy”, as used herein, refers to an —OH group.

The terms “alkoxy” and “hydroxyalkyl” refer to a -OR group, wherein R is alkyl.

In some embodiments of the present invention, the alkyl in the alkyl phosphate group and/or said alkyl-alkoxy phosphate group of the acid-releasing polymer is a C₈₋₂₀ linear alkyl, or a C₈₋₂₀ linear alkyl, or a C₈₋₁₅ linear alkyl, or a C₈₋₁₀ linear alkyl.

According to some embodiments, the polymeric moiety of the acid-releasing polymer is a polyoxyethylene, or a polyethylene glycol, such that the acid-releasing polymer is a polyoxyethylene alkyl ether phosphate. The acid-releasing polymer may be represented by general Formula I:

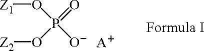

wherein:
each of Z₁ and Z₂ is independently H or a moiety represented by general Formula II:

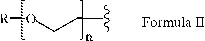

provided that at least one of Z₁ and Z₂ is said moiety;
A⁺ is H⁺ or a metal cation or an ammonium ion;
n is an integer that ranges from 50-200; and
R is a C₈₋₂₀ alkyl.

In some embodiments, the acid-releasing polymer is present in the composition as a free acid, a salt (e.g., sodium salt, ammonium salt, and the like) or a combination thereof in a buffered equilibrium.

In some embodiments, the acid-releasing polymer is present in the composition a mixture of species having one Z₁/Z₂ moiety represented by general Formula II and having two Z₁/Z₂ moieties represented by general Formula II.

The polyoxyethylene alkyl ether phosphate acid-releasing polymer, according to some embodiments of the present invention, is capable of releases phosphoric acid upon heating the composition to at least 160° C., at least 170° C., at least 180° C., at least 190° C. or at least 200° C. and higher.

While the released phosphoric acid can degrade cellulosic fibers, it is harmful to the inkjet machinery parts and environment; thus the composition, prior to heating, is substantially devoid of phosphoric acid at a temperature that ranges from room temperature to digital liquid jetting device working temperature (20-50° C.; typically 28-34° C. Nonetheless, while still essentially harmless to the digital liquid jetting device and other part of the inkjet machinery, the composition is having a pH that ranges from 2 to 5 at room temperature.

According to some embodiments of the present invention, prior to heating, the digital cutting composition described herein is substantially devoid of sodium dihydrogen phosphate, sulfuric acid and derivatives thereof, sodium hydroxide, sodium hydrogen sulfate and/or aluminum sulfate.

### Fabric-Penetration Composition

The fabric-penetration composition, according to some embodiments of the present invention, may essentially be the same as the fabric-cutting composition except for including the fiber-degrading agent therein - the fabric-penetration composition is devoid of a fiber-degrading agent. Optionally, the fabric-penetration composition may include other ingredients that are beneficial to the printing process and/or the finished product, as these are known in the art.

In some embodiments, the fabric-penetration composition may include a colorant, in the forms of a dye or pigment, which will be marking the cutting pattern on the fabric for easy identification of the cutting pattern. Alternatively, the fabric-penetration composition leaves no mark on the fabric.

In some embodiments, the fabric-penetration composition is one of the inkjet colored inks that takes part in any typical inkjet printing process.

In general, the fabric-penetration composition is characterized by one of more of:
a maximal particle size of less than 1 microns;
a dynamic viscosity at shear that ranges from 2 to 25 centipoise;
a Brookfield viscosity less than 25 centipoises at printing temperature; and
a surface tension that ranges from 24 to 35 mN/m.

Preferably, the fabric-penetration composition is characterized by all of the above characteristics, or at least most thereof.

### Cutting-Annulling Composition

According to another aspect of embodiments of the present invention, there is provided a cutting-annulling composition that includes a neutralizing agent and a carrier, the neutralizing agent can arrest and thereby annul the degradation, corrosion, etching, digestion and/or carbonization reactions of cellulosic or proteinous fibers, which can be effected by a corresponding fiber-degrading agent.

As used herein, the term “neutralizing agent” refers to a substance that can substantially neutralize the reactivity of the fiber-degrading agent upon contact therebetween. For example, an acid-releasing cutting agent can be neutralized by contacting with a base (e.g., NaOH, EDTA, ammonium hydroxide, various amines, and the like), thereby neutralizing its reactivity towards cellulosic fibers; and a proteolytic enzyme cutting agent can be neutralized by an inhibitor of the enzyme or a protein denaturation agent that degrades the enzyme, thereby neutralizing its reactivity towards proteinous fibers.

Exemplary protein denaturants include, for example, acids (e.g., picric acid, acetic acid, trichloroacetic acid and sulfosalicylic acid), bases (e.g., sodium bicarbonate), solvents (e.g., alcohol and most organic solvents), cross-linking reagents (e.g., EDC, formaldehyde, glutaraldehyde), chaotropic agents (e.g., urea, guanidinium chloride, lithium perchlorate), and disulfide bond reducers (e.g., 2-mercaptoethanol, dithiothreitol, tris(2-carboxyethyl)phosphine). Proteolytic enzymes can also be denatured by desiccation, mechanical agitation, radiation and high temperature.

Preferably, the cutting-annulling composition is characterized by one of more of:
a maximal particle size of less than 1 microns;
a dynamic viscosity at shear that ranges from 2 to 25 centipoise;
a Brookfield viscosity less than 25 centipoises at printing temperature; and
a surface tension that ranges from 24 to 35 mN/m.

Preferably, the cutting-annulling composition is characterized by all of the above characteristics, or at least most thereof.

### A Fabric Having a Cutting Pattern

In some embodiments of an aspect of the present invention, there is provided a fabric having a cutting and/or perforation pattern formed therein/thereon, effected by the process, composition and machinery presented herein.

The fabric having a digitally-formed cutting pattern can be shaped and fashioned into a garment or any other product comprising a fabric, hence the term “product” is meant to encompass any article of manufacturing comprising a fabric having a digitally-formed cutting pattern therein or thereon, according to embodiments of the present invention.

The final product of the process provided herein may be in the form of a roll of perforated fabric, ready to be transferred to the next processing step on the way to a garment or other textile article-of-manufacturing.

The finished product of the process, according to some embodiments of the present invention, is characterized by specific “fingerprints” imparted by the unique composition, process, machine and/or algorithm for digital cutting of fabrics presented in the foregoing.

For example, a chemical and/or spectral signature of the degraded fibers may be detected on the edges of the cut fabric piece, as well as remnants of the fiber-degrading agent or reaction by-products thereof. Elemental, FTIR, Raman, XPS, or EDX analyses may be used to identify the fingerprint of the process on the finished product.

It is expected that during the life of a patent maturing from this application many relevant compositions, processes, machines and algorithms will be developed and the scope of the terms composition, process, machine and algorithm is intended to include all such new developments a priori.

As used herein the term “about” refers to ± 10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Digital-Chemical Cutting of a Cellulosic Fabric

A proof of concept of some embodiments of the present invention was carried out by digitally executed chemical cutting of a cellulosic fabric using a cellulosic fiber-specific cutting agent in the form of an acid-releasing polymer.

For an exemplary cellulosic fiber-specific fiber-degrading agent, according to some embodiments of the present invention, the inventors have used a commercially available dispersant, known as SOLPLUS ® D540, which is a polyoxyethylene alkyl ether phosphate, provided by the Lubrizol Corporation, USA.

Exemplary compositions for digital cutting of a cellulosic fabric were formulated as follows:

| | |
|---|---|
| Cellulosic fiber-degrading agent (SOLPLUS ® D540) | 2-10 % |
| Surfactant (DYNOL® 360) | 0.1-0.5 % |
| Humectant/wetting agent (Propylene glycol; PG) | 50 % |
| Antibacterial agent | 0.05-0.2 % |
| Carrier (Deionized water) | to QS |
| pH | 2-4 |

The mechanical properties of the compositions for digital cutting of a cellulosic fabric included:
Maximal particle size of less than 1 microns;
a dynamic viscosity 12-20 centipoise at shear of 4000 rpm;
a Brookfield viscosity of 14 centipoises at 30° C.; and
a surface tension of 30-35 mN/m.

The printing machine Kornit Prestowas was used to print a straight line of droplets having a volume of 30 picoliter along a 100 % cotton fabric, equipped with a Fujifilm Dimatix Polaris 30 Pico liter (SG1024) printhead.

The fabric was then heated in a curing oven set to 160-200° C.

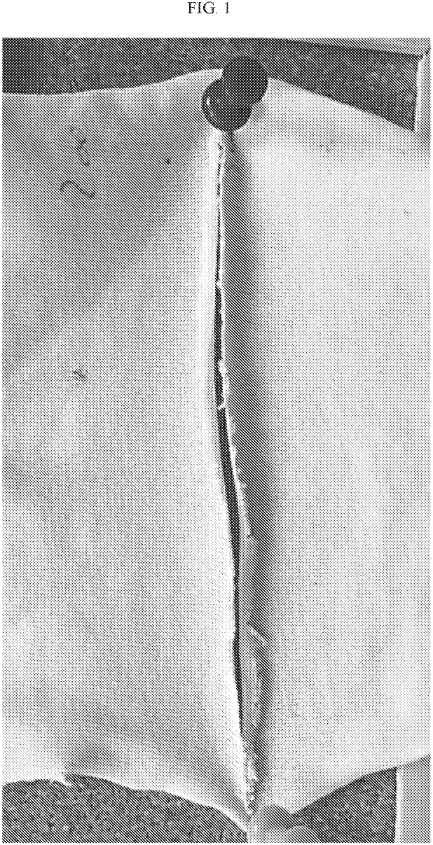

FIG. 1 presents a photograph of the cotton fabric cut using the digital cutting composition and process essentially as described herein.

As can be seen in FIG. 1, the 100 % cotton fabric was cut along a straight line, the area of which was contacted with the cellulosic fiber-degrading agent, according to some embodiments of the present invention.

The same composition and process were employed on a polyester fabric, and the fabric was not affected thereby, namely the cellulosic fiber-degrading agent used to cut a 100 % cotton fabric left no visible marks on the 100 % polyester fabric after the same treatment.

### Example 2

### Roll-to-Roll Digital-Chemical Cutting of a Cellulosic Fabric

A proof of concept of some embodiments of the present invention was carried out by digitally executed chemical cutting of a cellulosic fabric using a cellulosic fiber-specific fiber-degrading agent in an R2R printing configuration.

For an exemplary cellulosic fiber-specific fiber-degrading agent, according to some embodiments of the present invention, the inventors have used aluminum sulfate.

Exemplary compositions for digital cutting of a cellulosic fabric were formulated as follows:

| | |
|---|---|
| Cellulosic fiber-degrading agent (aluminum sulfate) | 40 % |
| Base (triethanolamine) | 0.2-0.8 % |
| Surfactant (DYNOL® 360) | 0.1-0.5 % |
| Humectant/wetting agent (glycerin) | 3-15 % |
| Antibacterial agent | 0.05-0.2 % |
| Carrier (Deionized water) | to QS |
| pH | 2-4 |

The mechanical properties of the compositions for digital cutting of a cellulosic fabric included:
Maximal particle size of less than 1 microns;
a dynamic viscosity 12-20 centipoise at shear of 4000 rpm;
a Brookfield viscosity of 14 centipoises at 30° C.; and
a surface tension of 30-35 mN/m.

The printing machine was configured to print an image and a cutting pattern juxtaposed to the image, printed by droplets of 35 picoliter in volume from a Fujifilm Dimatix Polaris 35 Pico liter (PQ35) printhead.

The fabric was then heated in a curing oven set to 140-160° C.

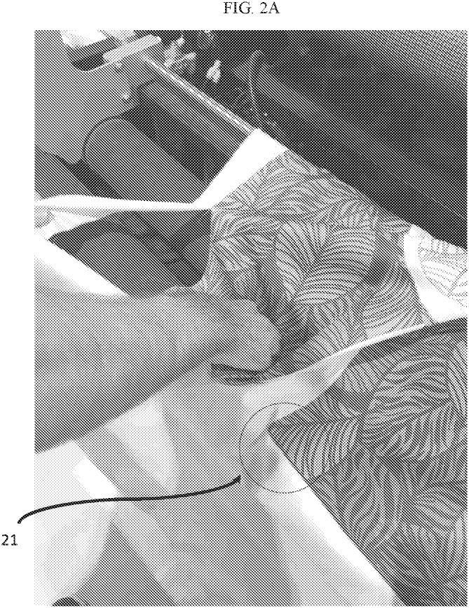

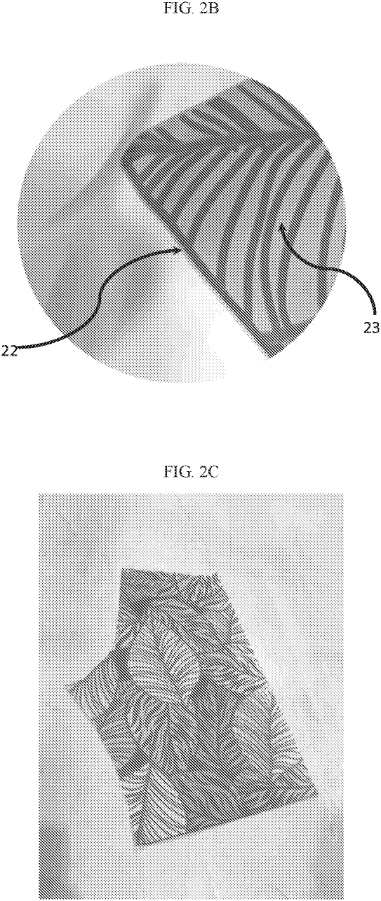

FIGS. 2A-C present photographs of the cotton fabric cut using the digital cutting composition and process essentially as described herein, wherein FIG. 2A shows the post-process tearing/cutting step and encircled areas 21 shown in FIG. 2B, FIG. 2B is the magnified version of encircled area 21 in FIG. 2A, showing colored cutting pattern 22 and image 23, and FIG. 2C shows the finished cut piece of fabric.

### Example 3

### A Fabric-Perforation Assay

According to some embodiments of the present invention, a fabric-perforation assay is conducted as a preparatory step towards processing a fabric for which perforation/cutting conditions are not yet known or need re-adjustment.

The below is a description of an exemplary none-limiting procedure for running the fabric-perforation assay.

A white cotton fabric, characterized by a tearing force of about 75 N/cm, was loaded on a Kornit Presto printing machine, equipped with two SG1024 printheads. The fabric-cutting composition, formulated for digital printing from an inkjet printhead, presented below, and a fabric-penetrating composition, formulated for digital printing from an inkjet printhead, presented below, were each printed in the same pattern, wherein the pattern was a series of 5 parallel 20 cm lines separated by 20 cm from each other.

The fabric-cutting composition was prepared as follows:

| | |
|---|---|
| Cellulosic fiber-degrading agent (aluminum sulfate) | 40%; |
| Base (triethanolamine) | 0.5%; |
| Surfactant (DYNOL® 360) | 0.3%; |
| Humectant/wetting agent (glycerin) | 10%; |
| Antibacterial agent | 0.1%; |
| Carrier (Deionized water) | to QS; and |
| pH | 3, |

and the fabric-penetrating composition was prepared as follows:

| | |
|---|---|
| Black pigment | 5%; |
| Binder | 15%; |
| Surfactant (DYNOL® 360) | 0.3%; |
| Humectant/wetting agent (glycerin) | 10%; |
| Antibacterial agent | 0.1%; and |
| Carrier (Deionized water) | to QS. |

Each of the abovementioned lines was printed at a drop-size of 30 pL and resolution of 600 × 800 DIP in equal increments, so as to afford a series of printed lines, each afforded by an increasing amount of the combined compositions. The control experiment was the first line, which received the fabric-penetrating composition (black inkjet ink) and none of the fabric-cutting composition.

The printed fabric was transferred to a drying hot-air oven heated to 160° C. for 5 minutes.

Thereafter, the fabric was analyzed on a Lloyd LS1 material testing machine to measure the force required to tear a 3 cm piece of the fabric, and the results are presented in Table 1 below

TABLE 1

| Line No. | fiber-cutting composition | fabric-penetrating composition | Tearing force (N/cm) |
|---|---|---|---|
| 1 | 0% | 100% | 75 |
| 2 | 100% | 0% | 40 |
| 3 | 100% | 50% | 15 |
| 4 | 50% | 100% | 35 |
| 5 | 100% | 100% | 7 |

As can be seen in Table 1, the tearing force resulting in printing the 100% of both compositions was about 7 N/cm that enables a manual separation and tearing of the fabric along the printed line. It is noted herein that a typical roll-to-roll printing machine exerts less than 2 N/cm tension force on the downstream roll, meaning that the fabric can be perforated by the process provided herein with good results.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

What is claimed is:

1. A process for chemically cutting a fabric, the process comprising:
loading the fabric comprising degradable fibers on a digital printing machine equipped with at least two digital liquid jetting devices;
digitally printing a fabric-cutting composition following a predetermined digital pattern, said composition comprises at least one activatable fiber-degrading agent suitable for degrading said degradable fibers;
digitally printing a fabric-penetrating composition essentially on the same location of said predetermined digital pattern; and
activating said activatable fiber-degrading agent in the fabric subsequent to said digitally printing, thereby obtaining a perforated fabric,
wherein said perforated fabric characterized by a level of perforation that corresponds to a tearing force of said perforated fabric, said tearing force is higher than a tension force applied on said perforated fabric by any part of said printing machine.

2-4. (canceled)

5. The process of claim 1, further comprising, prior to said digitally printing, performing a fabric-perforation assay for the fabric, wherein said fabric-perforation assay determines an amount of said activatable fiber-degrading agent that is applied on the fabric per unit area such that said perforated fabric is obtained subsequent to said activating.

6-7. (canceled)

8. The process of claim 1, wherein said level of perforation corresponds to a tearing force of less than 15 N/cm.

9. The process of claim 1, wherein said activatable fiber-degrading agent is a heat-activated fiber-degrading agent or a radiation-activated fiber-degrading agent, and said activating comprises heating and/or irradiating, respectively.

10. The process of claim 9, wherein said activating is effected in said printing machine.

11. The process of claim 10, wherein:
said printing machine is a roll-to-roll printing machine that comprises an upstream roll, a downstream roll, and a heating station;
said loading the fabric is effected from said upstream roll; and
re-rolling onto
said downstream roll, subsequent to said activating, at a tension force that is lower than a tearing force of said perforated fabric.

12-13. (canceled)

14. The process of claim 9, wherein said heating is effected to at least 110° C.

15. (canceled)

16. The process of claim 14, wherein said heat-activated fiber-degrading agent is an acid-releasing substance.

17. The process of claim 1, wherein the fabric essentially comprises only cellulosic fibers.

18. The process of claim 17, wherein said fiber-degrading agent is selected from the group consisting of aluminum sulfate, sodium aluminum sulfate, sodium bisulfate, copper(II) sulfate, iron(II) sulfate, cobalt(III) sulfate, iron(III) sulfate, zinc sulfate, sodium hydrogen sulfate, sodium dihydrogen phosphate, sodium hydroxide, an acid-releasing polymer, and any combination thereof.

19. The process of claim 18, wherein said fiber-degrading agent is aluminum sulfate.

20. The process of claim 1, wherein said fabric-penetrating composition comprises a colorant.

21. The process of claim 1, wherein:
said printing machine is a roll-to-roll printing machine that further comprises an upstream roll, a downstream roll, and a heating station;
the fabric consisting essentially of cellulosic fibers;
said activatable fiber-degrading agent is aluminum sulfate;
said fabric-penetrating composition further comprises a colorant;
said fabric-cutting composition and said fabric-penetrating composition are digitally printed on the fabric substantially concomitantly, essentially simultaneously, or sequentially, each from at least one of said at least two digital liquid jetting device;
each of said digital liquid jetting device is a digital inkjet printheads;
an amount of said fabric-cutting composition and said fabric-penetrating composition is selected to afford said perforated fabric, said perforated fabric is characterized by a tearing force that is lower than a tearing force of the fabric on said upstream roll and higher than a tension force of said downstream roll; and
said activating comprises heating to at least 110° C.

22. A perforated fabric, obtained by the process of claim 1.

23. The perforated fabric of claim 22, characterized by a tearing force that ranges 1-10 N/cm.

24. The perforated fabric of claim 22, characterized by a cutting pattern marked by a colorant.

25. The perforated fabric of claim 22, characterized by a spectral feature characteristic to a fabric cut by said activatable fiber-degrading agent.

26. The perforated fabric of claim 22-24, in a form of a roll of said perforated fabric.

27. A cut fabric, obtained by tearing said perforated fabric obtained by the process of claim 1.

28. The cut fabric of claim 27, characterized by a spectral feature characteristic to a fabric cut by said activatable fiber-degrading agent.

29. A fabric cutting composition, suitable for the process of claim 1.

30. The composition of claim 29, being formulated for digital inkjet printing from digital liquid jetting device.

31. The composition of claim 29, comprising an activatable fiber-degrading agent at a concentration of less than 5 wt% of the total weight of the composition.

32. (canceled)

33. The composition of claim 29, further comprising a colorant.

34. The composition of claim 29, substantially devoid of a colorant.
